(19) United States
(12) Patent Application Publication
(10) Pub. No.: US 2021/0341350 A1
(43) Pub. Date: Nov. 4, 2021

(54) METHOD FOR GENERATING AN EXCITER SIGNAL AND FOR ACOUSTIC MEASURING IN TECHNICAL HOLLOW SPACES

(71) Applicant: MEOWELL GMBH, Ilmenau (DE)

(72) Inventor: Peter PEYERL, Ilmenau (DE)

(21) Appl. No.: 17/280,229

(22) PCT Filed: Sep. 19, 2019
(86) PCT No.: PCT/EP2019/075139

§ 371 Date: Mar. 26, 2021

(30) Foreign Application Priority Data
Sep. 26, 2018 (DE) 10 2018 123 797.9

(51) Int. Cl. G01M 3/24; G01N 29/04; G01N 29/07; G01N 29/46

(52) U.S. Cl. CPC G01M 3/243; G01N 29/043; G01N 2291/2636; G01N 29/46; G01N 29/07

(57) ABSTRACT

The invention relates to a method for acoustic measuring in technical hollow spaces, for example, for measuring reflection points along long pipelines. The method begins with establishing a broadband exciter frequency range. This is followed by establishing interference frequencies which should not be in the exciter signal, and generating a precursor signal over the frequency range with the omission of the interference frequencies. Then, the precursor signal is coupled into the pipeline and a precursor reflection signal reflected out of the pipeline is received. The precursor signal is compared with the precursor reflection signal and damping frequencies are determined at which the precursor signal on the measuring path along the pipeline is damped much more than the average damping of the entire precursor signal. Then, an exciter signal is generated over the exciter frequency range with the omission of the interference frequencies and the damping frequencies. This is followed by coupling the exciter signal into the pipeline and receiving a measuring signal reflected out of the pipeline, as well as evaluating the reflected measuring signal using suitable evaluation methods.

The invention also relates to a method for generating an exciter signal and a device for carrying out this method.

### BACKGROUND OF THE INVENTION

The invention relates to a method for acoustic measuring in or along pipelines. In particular, such methods can be utilized for optimizing sound transmission and measuring reflections of acoustic signals in or along pipelines. The position of leakages or discontinuities in pipelines, liquid levels in vertically installed piping systems, etc. can be determined using such signals.

Various patents exist on the subject of measuring liquid levels in vertically installed pipes.

EP 2 169 179 B1 discloses a method and a device for exclusive detection of the fluid depth in a wellbore which corresponds to a vertically installed piping system. To identify the position of a fluid depth in a wellbore of a deep borehole, an acoustic event is generated on the ground surface, which generates pressure waves. The pressure waves run deep into the borehole and are at least also reflected at the fluid depth. The pressure waves returning to the ground surface are picked up and the time of travel since the acoustic event is measured. The picked-up and measured pressure waves are evaluated together with the associated time of travel, from which conclusions can be drawn about the location of the fluid depth. The acoustic event is generated as a signal pattern having a predetermined, time-variable frequency spectrum. The signal pattern is emitted as a vibration event into the borehole. During the analysis, vibration events are filtered out of the picked-up, reflected signals, which vibration events correlate with the emitted signal pattern. The location of the fluid depth is deduced from the vibration events correlating to the emitted signal pattern and the time of travel since the emission of the signal pattern. The device for carrying out the method also described in this publication has a vibration-emitting device at the ground surface which generates signal patterns with a predetermined, time-variable frequency spectrum and emits them into the wellbore. Furthermore, provision is made for a measuring device for receiving signals originating from the wellbore and an electronic analysis unit which analyzes signals picked up by the measuring device. The analysis unit determines the vibration events correlating to the emitted signal patterns and determines the location of the fluid depth.

DE 10 2004 016 196 A1 discloses a method for destruction-free material testing. Here, the generation of an exciter signal is described. The aim of this method is to reduce undesired oscillation modes of the electro-mechanic system, in particular in the case of piezo oscillators having multiple oscillation modes, by means of a spectrally matched exciter function voltage curve. First, a broadband exciter frequency range is established in which an exciter signal is to be generated. This is done by broadband exciting at predetermined time intervals for calibration and frequency-analyzing the feedback path after exciting has been switched off. Interference frequencies are also determined and eliminated.

Furthermore, DE 10 2012 101 667 A1 discloses a method which describes a vibronic measuring device for determining and/or monitoring at least one process variable of a medium in a container. Here, the object of the device is to make the vibronic determination of process variables more resistant to the influence of external vibration by using an oscillating unit. This is done by the control/evaluation unit being configured to, upon occurrence of at least one external vibration, as a function of frequency and/or amplitude of the external vibration, control the oscillation exciter in such a way that this external vibration is suppressed. In order to suppress these external vibrations, the control/evaluation unit controls, for example, at least one amplitude and/or the frequency in such a way that the useful signal differs from the external vibrations in such a way that it can be recognized as a useful signal by the electronics processing the received signal.

It should be understood that such acoustic measuring cannot be carried out only in deep drilling but also in other fields of application, for example, when hollow bodies filled with air, other gases or liquid media such as, e.g., pipelines, parallel tube heat exchangers, etc. are to be examined. For the purpose of the present invention pipelines are principally understood to mean elongated substantially uniform hollow spaces, in which a medium is located, in which sound waves or acoustic signals can spread, wherein the total damping of the signals must be small enough so that the acoustic signals propagate over the desired measuring length and reflect back to the place of transmission and are then still measurable. Especially in the case of very long pipes (a few hundred meters to several kilometers), pipes having a complicated, partly very different geometry, pipes with many possible reflection points for the sound waves, components with signals coupled into the space between an outer and an inner pipe and in case of high interfering noise in the pipe or its vicinity, the previously known measuring methods fail regularly.

Besides interferences due to the constructional features (e.g., abrupt changes in diameter) of the pipes to be measured, there are further interference variables in electrical measuring methods, which disturbance variables are based on electromagnetic interference on the used sensors or electrical lines and which disrupt sensitive measurements or make them impossible.

### SUMMARY OF THE INVENTION

It is an object of the present invention, based on the cited prior art, to provide an improved method for acoustic measuring along long pipelines, which method even under difficult conditions provides reliable readings. In particular, the method should enable locating of unknown reflection points in technical hollow bodies and mainly along long pipelines such as, for example, faulty welds, fluid depths, liquid levels, leaks, etc., while known reflection points such as, e.g., periodically recurring impacts on pipe sections, immobile fixtures in the hollow bodies, etc. should not falsify the measurement result. For this purpose, a measurement method is required that can be optimally and easily adapted to various conditions. In addition, a device for carrying out such a method is to be provided.

This object is achieved by a method for acoustic measuring in or along long pipelines according to appended claim 1. A device for acoustic measuring in a pipeline is also specified according to appended claim 7 to achieve the object.

The method according to the invention for acoustic measuring in or along a pipeline begins first with establishing a broadband exciter frequency range in which an exciter signal is to be generated. For example, the exciter frequency can range from a lower cut-off frequency fᵤ=5 Hz up to an upper cut-off frequency fₒ=300 Hz. However, other exciter frequency ranges up to ultrasound are also conceivable. The specifically suitable frequency range depends on the properties of the pipe to be examined.

In a further step, interference frequencies are established which should not be included in the exciter signal. Such interference frequencies may result from the structure of the pipeline to be measured and/or from environmental conditions and may be known or determined. For example, the supply frequencies (50 Hz, 60 Hz and harmonics thereof) and converter frequencies (typically 20 . . . 40 Hz and harmonics thereof) are usually considered. These known interference frequencies can be considered as standard values. Furthermore, interference frequencies due specifically built-in or periodically arranged reflectors along the pipeline (e.g., pipe junctions) can form, or other cyclic signals in the frequency range considered can occur which are established as interference frequencies.

According to a preferred embodiment, a measurement of acoustic interference signals that, e.g., occur at a pipeline without coupling the precursor or the exciter signal as a basic noise, is carried out to establish the interference frequencies. The frequencies of the measured interference signals above a predetermined interference signal threshold are then established as interference frequencies. The measured interference signal includes both possible interfering noises and disturbing electromagnetic interferences. Establishing the interference frequencies occurring in said basic noise can take place automatically based on predetermined threshold values of the amplitude of individual frequency lines or/and also manually by evaluation of the signal depicted.

According to a modified embodiment, the properties of the signal transmission chain can be taken into account when establishing or determining the interference frequencies. In particular, e.g., resonance frequencies of a loudspeaker that is used to couple the acoustic signals into, e.g., the pipeline, can be treated as interference frequencies and can be excluded from the precursor signal or the exciter signal. Also, the frequency response of the sensors that receive the reflected signals can be taken into account in establishing the interference frequencies by adjusting the precursor signal and later, the exciter signal accordingly.

It should be understood that the subsequent measurements can be carried out much more sensitively and precisely if these interfering frequencies are suppressed. However, the invention goes beyond such suppression by generating an exciter signal for the actual measurement, which does not even contain such interference frequencies. For this purpose, in a further step of the method according to the invention, a precursor signal is generated over the established exciter frequency range but excluding the interference frequencies. In doing so, the entire signal energy can be directed in the frequency ranges that can be evaluated as part of the measurement. Thus, the precursor signal is a broadband transmission signal (e.g. 5 Hz . . . 300 Hz) without the interference frequencies. In modified configurations, the precursor signal (and later the exciter signal) is chosen to be more narrowband, for example in the range of 5 Hz to 50 Hz, in order to be able to focus more transmission power in the frequency range of interest for specific applications.

The generation of the acoustic signals required for the measurement, i.e. the precursor signal and the exciter signal (see below) are preferably carried out digitally, in that the signals are calculated by appropriate software in a computing device (microcontroller, digital signal processor, FPGA, etc.).

In the next step of the method, the coupling of the thus generated precursor signal into the pipeline and the receiving of a precursor reflection signal reflected from the pipeline take place. Preferably, the precursor signal (as later the exciter signal) is converted to an analog signal by a digital-analog converter, and coupled into the pipeline, especially into the pipe interior. Coupling takes place, for example, with the aid of one or more loudspeakers. Suitable acoustic sensors (e.g., microphones), which can be located at different points at the pipe, are used to detect the precursor reflection signal, which is reflected and influenced by the pipe.

In the subsequent step, the precursor signal is compared with the precursor reflection signal for determining damping frequencies in which the precursor signal on the measuring path along the pipeline is damped much more than the average damping of the entire precursor signal. For this purpose, preferably, the precursor reflection signal is converted into a digital signal by means of an AD converter s and the comparison with the precursor signal is carried out again by appropriate software/algorithms in a suitable computing device (microcontroller, digital signal processor, FPGA).

By coupling the precursor signal and evaluation of the precursor reflection signal it can be determined which signal components along the pipeline can be transmitted well and which signal components are strongly damped or even eliminated.

In the subsequent step of the method according to the invention, an exciter signal is generated over the exciter frequency range, excluding the previously determined or established interfering frequencies and also the determined damping frequencies. The final exciter signal generated in this way is broadband in the exciter frequency range and at the same time dispenses with at least one specifically omitted frequency, usually several frequencies that were previously determined to be interference frequencies or damping frequencies. This allows the energy of the exciter signal to be focused exactly on the frequency ranges in which neither interference frequencies nor damping frequencies are present.

In the following method step, the exciter signal generated in this way is coupled into the pipeline and a measuring signal reflected from the pipeline is received. Coupling and receiving are again carried out with the aid of the loudspeakers or sensors already mentioned above. In a preferred embodiment, the loudspeaker can also be operated as a microphone in reverse mode, so that no independent sensors are required.

In a last step, the evaluation of the reflected measuring signal using appropriate evaluation methods is carried out. In a manner known per se—but with accuracy improved according to the invention—various parameters/properties of the pipeline or the associated piping system can be determined. Such parameters can be, for example:
special acoustic transmission conditions in the pipe,
joints,
other reflections in the pipe or at the end of the pipe,
acoustic properties of media in the pipe, such as damping/absorption, speed of sound, time of travel, etc.

These acoustic parameters can be used in turn, depending on the application, to draw conclusions about material properties, propagation conditions, degree of pollution, leaks, etc.

A major difference between measuring methods according to the prior art and the method according to the invention is thus that interference signals are suppressed or filtered out not only in the receive path, but that the interference frequencies and possibly damping frequencies are not even in the exciter signal. The energy available for measuring which has to be coupled with the exciter signal into the system to be measured, thereby can be distributed on frequency ranges that can be transferred well in the system (pipeline) and evaluated.

According to an expedient embodiment, the method is performed continuously so that pipelines are monitored continuously. The interference frequencies and damping frequencies that have been established once can be kept constant in several measuring cycles, since short-term changes in these interference variables are not to be expected. In a modified embodiment it can be useful also that the determination of the interference and damping frequencies is carried out anew at predetermined intervals in order to be able to take into account, for example, the speed control of motors, altered frequencies of a frequency converter and the like.

According to a modified embodiment a test signal can be generated from the exciter signal. For this purpose, a test frequency is selected, which is within the exciter frequency range and is different from the detected interference frequencies. The test frequency correlates with periodic reflection points in the pipeline and can be determined from the measuring signal. The distance between periodically recurring reflection points, e.g., seams between pipe sections of equal length, is known so that a high power density can be achieved by coupling in the narrow-band test signal. From the reflections that occur, taking into account the distance, the speed of propagation can be determined, for example.

The method according to the invention comprises the generation of an exciter signal for acoustic measuring along pipelines. This section of the method begins with establishing a broadband exciter frequency range in which an exciter signal is to be generated. In the next step, interference frequencies are established which should not be in the exciter signal. Finally, the exciter signal is generated over the exciter frequency range with the omission of the interference frequencies. Furthermore, after establishing the interference frequencies, a precursor signal is generated over the exciter frequency range with the omission of the interference frequencies. This is followed by coupling the precursor signal into a pipeline to be measured and receiving a precursor reflection signal reflected from the pipeline. By comparing the precursor signal with the precursor reflection signal damping frequencies are determined at which the precursor signal on the measuring path along the pipeline is damped much more than the average damping of the entire precursor signal. When the exciter signal is finally generated, both the interference frequencies and the damping frequencies are omitted. Details on the generation of the exciter signal are apparent from the above-mentioned description of the method for acoustic measuring along long pipelines and the associated embodiments, which are also applicable here accordingly.

The exciter signal generated according to the invention is significantly different from the commonly used pulse techniques utilized for the same applications, in which broadband exciting takes place at the expense of loss of a large portion of the energy available for the measurement due to the required filtering upon receipt of the reflected signal. There is also a clear difference to methods such as those used in the above-mentioned patent EP 2 169 179 B1, for example, for there a continuous chirp with lower and upper frequency is used without taking into account several frequency ranges with the exclusion of previously determined interference frequencies.

It has proven necessary for the generation of the exciter signal, preferably also of the precursor signal, to use a so-called multi-sine burst. In the case of a multi-sine burst, both the duration and the form of the signal can be adapted in the desired way using known algorithms of signal processing to omit individual frequencies—namely the interference frequencies and the damping frequencies—from a broadband signal.

### BRIEF DESCRIPTION OF THE DRAWINGS

Further advantages and details of the invention will become apparent from the following description of a preferred embodiment, with reference to the drawing.

FIG. 1 shows steps of the method according to the invention as a flowchart and related signal profiles;

FIG. 2 shows a spectrum of a multi-sine signal with any desired spectral components;

FIG. 3 shows the time course of a multi-sine signal consisting of three sine components;

FIG. 4 shows the time course and spectrum of a sine burst;

FIG. 5 shows the time course and spectrum of a multi-sine burst;

FIG. 6 shows the time course and spectrum of a multi-sine burst in which the sine component f₂ has been shifted by 180°;

FIG. 7 shows a flowchart for optimizing a multi-sine burst;

FIG. 8 shows exemplary signal profiles occurring in the steps according to FIG. 6;

FIG. 9 shows the time course and spectrum of the optimized multi-sine burst;

FIGS. 10 A-C show a comparison of a classic pulse technique, method with changing frequency (chirp) and multi-sine burst with a plurality of frequency bands.

### DETAILED DESCRIPTION OF THE INVENTION

The preferred embodiment described hereinafter in exemplary fashion is based on the use of a broadband multi-sine burst as the exciter signal, said multi-sine burst having a spectrum optimized according to the invention in order to selectively exclude interference frequencies and possibly damping frequencies.

A multi-sine is a broadband periodic signal in which the spectral power of the individual frequency components can be easily set.

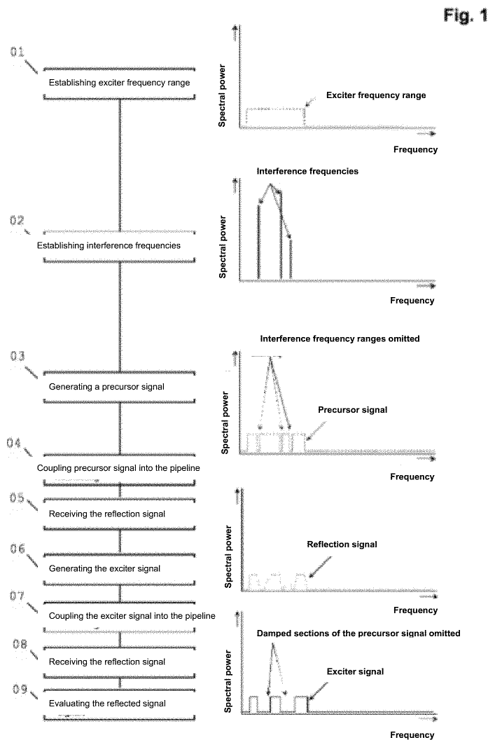

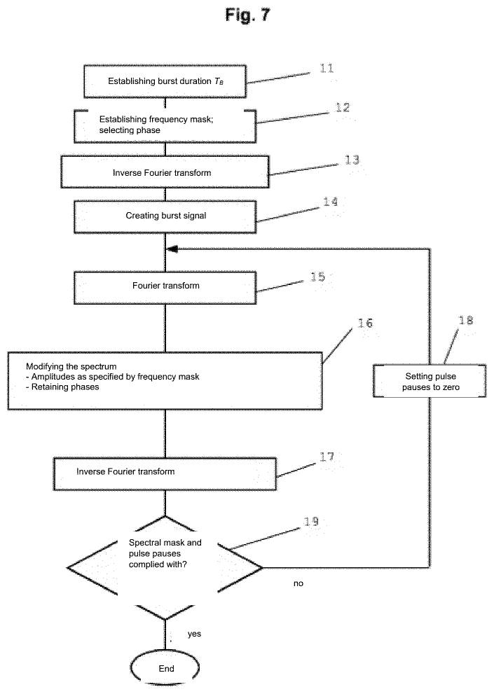

FIG. 1 shows essential steps of the method according to the invention as a flowchart and the associated signal profiles in a simplified form. The method for acoustic measuring, in particular of reflection points, in or along long pipelines begins at step 01 with the establishing of a broadband exciter frequency range in which a desired exciter signal is to be formed. In step 02, interference frequencies are established or defined which should not be in the exciter signal. In step 03, a precursor signal is generated over the exciter frequency range with the omission of the previously established interference frequencies. In step 04, coupling the generated precursor signal into a pipeline to be examined takes place. In step 05, a precursor reflection signal reflected from the pipeline is received. In step 06, the actual desired exciter signal is generated, for which purpose a comparison of the precursor signal with the precursor reflection signal and a determining of damping frequencies at which the precursor signal on the measuring path along the pipeline is damped much more than the average damping of the entire precursor signal are carried out and wherein generating the exciter signal over the exciter frequency range is carried out with the omission of the interference frequencies and the damping frequencies. The details of generating the exciter signal are described in greater detail below with reference to FIG. 7. In step 07, the exciter signal generated is coupled into the pipeline. In step 08, a measuring signal reflected from the pipeline is received. And finally, in step 09, the reflected measuring signal is evaluated using appropriate evaluation methods.

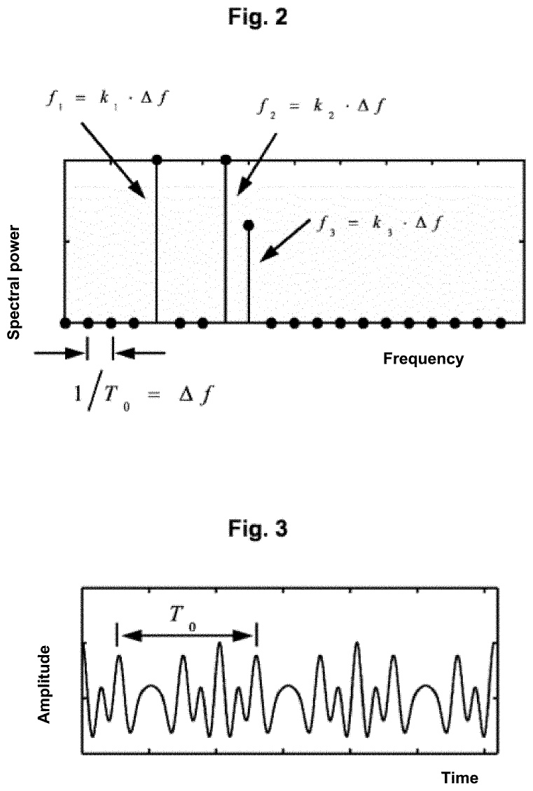

FIG. 2 shows the procedure using the spectrum of a multi-sine signal with any desired spectral components. Assuming a period duration of the multi-sine signal of T₀, multiple sine signals can be accommodated within that time period if the integral multiple of the period duration T₀ of the sine signals corresponds to the period duration T₀ of the multi-sine signal. Therefore, the following must apply:

kTₛ=T₀ or T₀fₛ=k

In this case, fₛ is the frequency of the corresponding sine component. Therefore, any number of sine components can be accommodated in the entire signal as long as their frequency is an integer multiple of Δf=1/T₀. In FIG. 1, the permitted frequencies are labelled by small circular areas. In the example shown, only 3 of the possible frequencies are actually used. The strength of each individual sine component can be predetermined by the height of the spectral lines. In the example, two sine signals have been selected to have the same strength, a third has been selected to be somewhat weaker.

FIG. 3 shows the time signal which results from the superposition of the three sine components selected in FIG. 1. It is shown over three periods. In the case shown, the individual spectral lines are independent of one another, so that any desired performance spectrum can be specified very flexibly. By inverse Fourier transform the time signal can be calculated therefrom which finally is converted into a voltage signal with the predetermined spectrum by means of a DA converter.

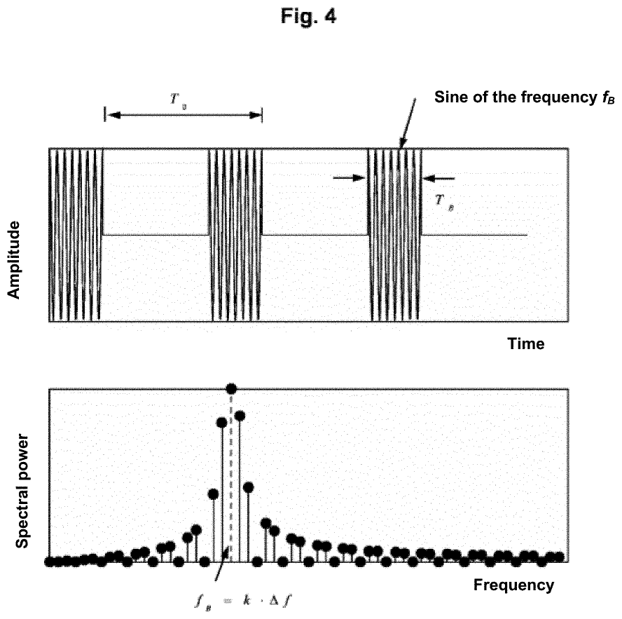

FIG. 4 shows the time course and the spectrum of a sine burst. In the case of a burst signal, the aforementioned independence of the spectral lines is no longer given. A sine signal of frequency f_{B} is sent out only during the time interval T_{B}. The spectrum of this signal now consists not only of the individual spectral line of the frequency f_{B} (dashed line) but scatters over a certain range around this frequency. The smaller T_{B} is selected, the stronger the scattering.

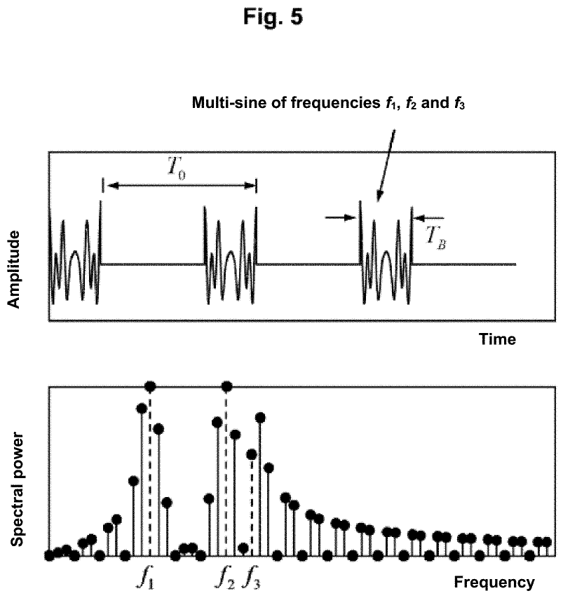

FIG. 5 shows the time course and the spectrum of a multi-sine burst, wherein the burst signal consists of the same sine components as shown in FIG. 1. The intended sine components are marked by dotted lines. A number of spectral components arise that were not originally intended. These arise from the superposition of the individual spectra (see lower diagram in FIG. 3) of the sine bursts at different frequencies. The resulting overall spectrum is therefore difficult to predict.

Changing the phasing of the three sine components relative to one another may result in another overall spectrum because spectral components can superimpose constructively or destructively.

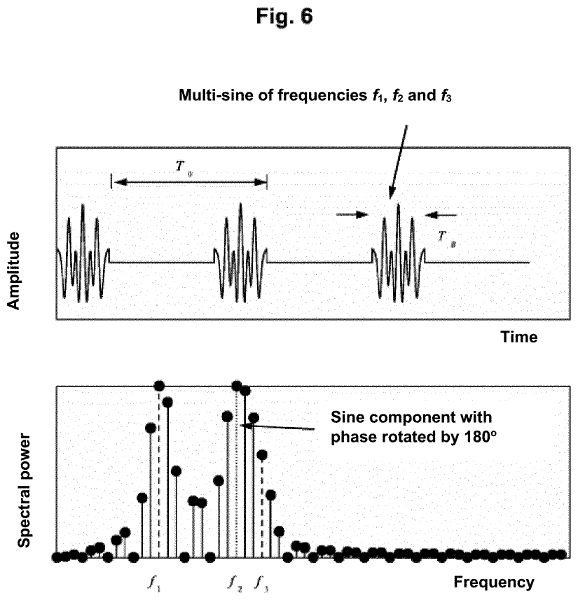

FIG. 6 shows the time course and the spectrum of a multi-sine burst, wherein the sine component f₂ has been shifted by 180°.In the example shown, the same sine components as in FIG. 4 have been used. Only the phase of the frequency component f₂ was rotated by 180° . As can be seen, the change in the phasing has led to a considerable modification of the overall spectrum. It can be deduced that by a suitable choice of the phases of the sine components, for burst signals also it is possible to comply with a predetermined frequency mask at least approximately. As a result of the superposition of many spectral lines, the determination of suitable phase values is a complex optimization problem. One possibility for an approximate solution to this optimization problem is an iterative process, as described below.

FIG. 7 shows a flowchart for the approximate solution of the above optimization problem with the illustration of typical signal profiles and spectra. The sequence consists of the following steps:

11. Establishing the burst duration T_{B}.

12. Establishing the frequency mask of the multi-sine test signal. In the example, the signal should only have spectral components within the areas B1 and B2.

13. Determining the time signal by means of inverse Fourier transform. The phases of the individual spectral components can be chosen randomly.

14. Adding zeros to the desired signal length T₀ to get a burst signal.

15. Calculating the complex amplitude spectrum of the burst by means of Fourier transform.

16. Since the spectrum deviates from the intended shape, the amplitudes of the spectral components must be set again as established in step 12. However, those values are to be retained as the phase angle as they resulted in the spectrum according to step 15.

17. Determining the time signal by means of inverse Fourier transform.

18. Due to the changes in the amplitude spectrum, the signal no longer has a pronounced pulse pause. To restore such pulse pause, all related signal components are set to zero.

19. Jumping back to step 15 with this signal and repeating the process until the spectral mask and the pulse pause are complied with an accuracy to be specified.

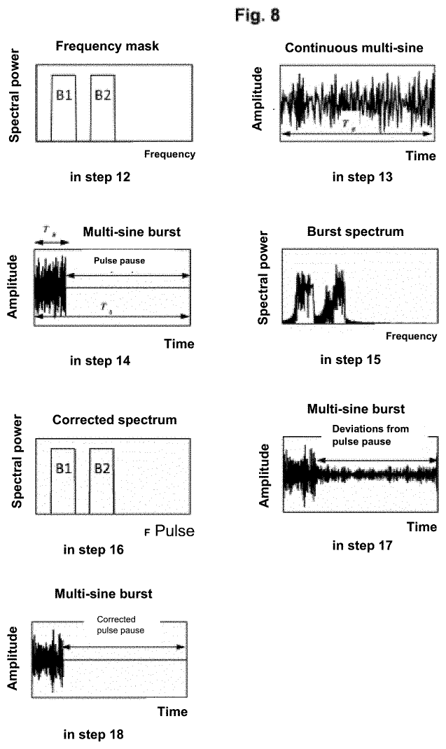

FIG. 8 shows exemplary signal profiles as they occur in the steps described above.

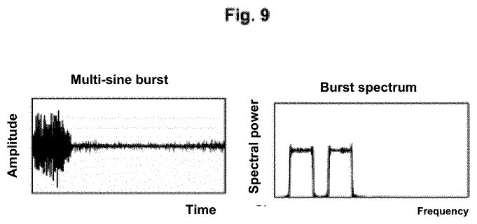

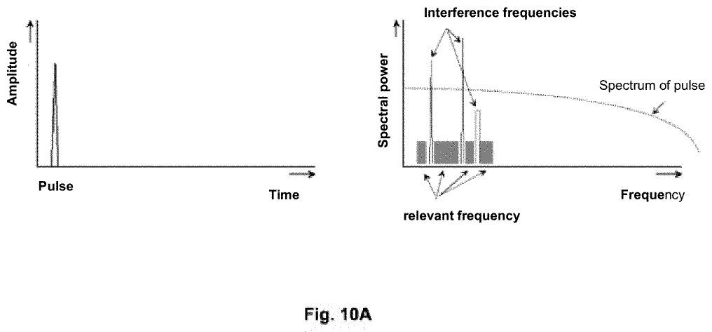

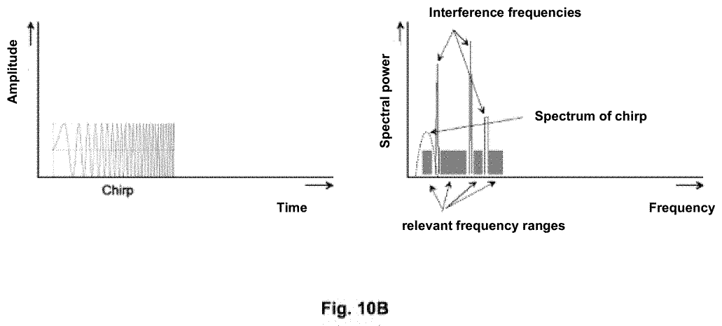

FIG. 9 shows the time course and the spectrum of the optimized multi-sine burst, thus the result of the optimization according to FIG. 6. With the exception of minor deviations, the test signal complies with both the spectral and the temporal mask.

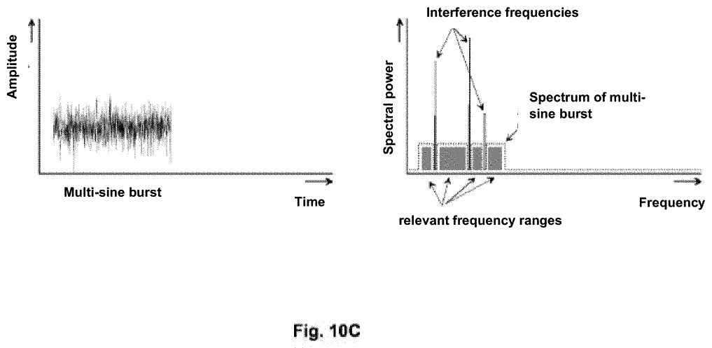

For the final clarification of the differences between the present invention and the well-known methods, FIG. 10 shows in each case the signal profile in comparison to the classic pulse technique (FIG. 10A), methods with changing frequency (chirp from fᵤ to fₒ) (FIG. 10B), and the method according to the invention multi-sine burst with a plurality of frequency bands (FIG. 10C).

As the person skilled in the art, can find detailed instructions for the construction of individual units of a suitable device, as well as mathematical and metrological procedures in the signal analysis, for example from the above cited EP 2 169 179 B1, the repetition of these well-known aspects is dispensed with for the most part.

1. A method for acoustic measuring in or along a pipeline, comprising the steps of:
establishing a broadband exciter frequency range in which an exciter signal is to be generated;
establishing interference frequencies which should not be in the exciter signal;
generating a precursor signal over the exciter frequency range with the omission of the interference frequencies;
coupling the signal precursor into the pipeline and receiving a precursor reflection signal reflected from the pipeline;
comparing the precursor signal with the precursor reflection signal and determining damping frequencies at which the precursor signal on the measuring path along the pipeline is damped much more than the average damping of the entire precursor signal;
generating an exciter signal over the exciter frequency range with the omission of the interference frequencies and the damping frequencies;
coupling the exciter signal into the pipeline and receiving a measuring signal reflected out of the pipeline;
evaluating the reflected measuring signal using suitable evaluation methods, wherein the exciter signal is generated as a multi-sine burst by the following steps:
11. Establishing a burst duration TB;
12. Establishing a frequency mask of the multi-sine test signal;
13. Determining the time signal by means of inverse Fourier transform;
14. Adding zeros to the desired signal length T0 to get a burst signal;
15. Calculating the complex amplitude spectrum of the burst by means of Fourier transform;
16. Modifying the spectrum by setting the amplitudes of the spectral components as established in step 12 with retaining the values of the phase angles as they resulted in the spectrum according to step 15;
17. Determining the time signal by means of inverse Fourier transform;
18. Restoring the pulse pause by setting all related signal components to zero;
19. Jumping back to step 15 and repeating the steps until the spectral mask and the pulse pause are complied with an accuracy to be specified.

2. The method according to claim 1, wherein also the precursor signal is generated as a multi-sine burst.

3. The method according to claim 1, wherein the exciter frequency range is established in the range of 1 Hz to 1 kHz, preferably ranging from a lower cut-off frequency fᵤ=5 Hz up to an upper cut-off frequency f_{o =300} Hz.

4. The method according to claim 1, wherein measuring acoustic interference signals occurring at the pipeline without coupling of the precursor or the exciter signal, is carried out for establishing interference frequencies, wherein the frequencies of the measured interference signals are established above a predetermined interference signal threshold as interference frequencies.

5. The method according to claim 1, wherein those frequencies are determined as the damping frequencies for which the damping is at least greater by a factor of 2 than the average damping of the precursor signal.

6. The method according to claim 1, wherein a test signal is generated which has a frequency within the exciter frequency range which frequency correlates with periodic reflection points in the pipeline, and in that the test signal is coupled into the pipeline in order to determine the speed of propagation taking into account a known distance between the periodic reflection points.

7. A device for acoustic measuring in or along a pipeline, comprising:
a unit for generating an exciter signal;
a sound generator for coupling the exciter signal generated into the hollow space;
a sensor for detecting a measuring signal reflected from the hollow space;
an analysis unit for evaluating the measuring signal;
wherein the analysis unit is configured to carry out a method according to claim 1.
